(19) United States
(12) Patent Application Publication
(10) Pub. No.: US 2006/0204218 A1
(43) Pub. Date: Sep. 14, 2006

(54) Method and apparatus for selecting a recording device from among a plurality of recording devices

(75) Inventor: Hiromitsu Matsumura, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/151,004

(22) Filed: Jun. 13, 2005

(30) Foreign Application Priority Data
Mar. 10, 2005 (JP) 2005-068138

(51) Int. Cl. H04N 5/91

(52) U.S. Cl. 386/83

(57) ABSTRACT

A data recording apparatus includes: an obtaining unit that obtains a usage state of each of recording devices; an extracting unit that extracts a channel device other than a channel device having a largest number of recording devices that are connected to the channel device and currently used, based on the usage state obtained; and a selecting unit that selects a recording device that is not currently used from among recording devices that are connected to the channel device extracted, based on the usage state obtained.

### CROSS-REFERENCE TO RELATED APPLICATIONS

This application is based upon and claims the benefit of priority from the prior Japanese Patent Application No. 2005-068138, filed on Mar. 10, 2005, the entire contents of which are incorporated herein by reference.

### BACKGROUND OF THE INVENTION

1. Field of the Invention

The present invention relates to a technology for appropriately selecting a recording device from among a plurality of recording devices included in a data backup system.

2. Description of the Related Art

In recent years, with the widespread use of broadband, the amount of information used by companies and the like has been dramatically increased. Furthermore, with the increase in the amount of information, the capacity of recording devices for storing data has been increased. To efficiently store such data, technologies, such as storage area network (SAN) and network attached storage (NAS), in which a plurality of computers and a plurality of recording devices are connected to each other via a network, have been used.

In these systems, a plurality of recording devices with different attributes may be connected, or recording devices of different types may be connected in the same system. In conventional technology, one approach is known in which, in a calculator system where recording devices of different types are mixed, information about the recording devices connected to a network are compared with conditions included in a request from a calculator to select a recording device having a recording area satisfying the conditions (for example, refer to Japanese Patent Application Laid-Open No. 2003-345631).

Another approach is known in which, when a new device is required, a managing unit retaining information about a connection state of each calculator and a recording device sub-system is notified of the capacity and type of the required device, and based on the information, a recording device having a recording area that satisfies the requirements is selected (for example, refer to Japanese Patent Application Laid-Open No. 2001-142648).

However, in the conventional technology described above, a plurality of tape drives is connected for each fiber channel card. Therefore, when data is recorded by using the tape drives via the fiber channel card, a transfer band of the fiber channel card is saturated, thereby disadvantageously reducing data transfer efficiency. Particularly, transfer efficiency is significantly reduced with the increase of the number of tape drives.

On the other hand, if one tape drive is assigned per fiber channel card, fiber channel cards are required as many as the number of tape drives, thereby disadvantageously increasing cost.

It is an object of the present invention to at least solve the problems in the conventional technology.

A data recording apparatus according to an aspect of the present invention, which is a data recording apparatus in a system including a plurality of channel devices and a plurality of recording devices, includes: an obtaining unit that obtains a usage state of each of the recording devices; an extracting unit that extracts a channel device other than a channel device having a largest number of recording devices that are connected to the channel device and currently used, based on the usage state obtained; and a selecting unit that selects a recording device that is not currently used from among recording devices that are connected to the channel device extracted, based on the usage state obtained.

A method according to another aspect of the present invention, which is a method of recording data in a system including a plurality of channel devices and a plurality of recording devices, includes: obtaining a usage state of each of the recording devices; extracting a channel device other than a channel device having a largest number of recording devices that are connected to the channel device and currently used, based on the usage state obtained; and selecting a recording device that is not currently used from among recording devices that are connected to the channel device extracted, based on the usage state obtained.

A computer-readable recording medium according to still another aspect of the present invention stores a computer program that causes a computer to execute the method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a drawing of a data recording system according to an embodiment of the present invention;

FIG. 2 is a drawing for explaining a connection state of data recording devices according to the embodiment;

FIG. 3 is a drawing of a usage state table regarding the usage state of tape drives and backup servers;

FIG. 4 is a block diagram of a backup server, a backup management server, or a terminal according to the embodiment;

FIG. 5 is a block diagram of the data recording device;

FIGS. 6 and 7 are drawings for explaining the connection state of the data recording devices shown in FIG. 2;

FIG. 8 is a drawing of a display screen of a terminal on which the usage state of the tape drives is displayed;

FIG. 9 is a flowchart of a process performed by the data recording device; and

FIG. 10 is a flowchart of a selecting process performed by the data recording device according to the embodiment.

### DETAILED DESCRIPTION OF THE PREFERRED EMBODIMENTS

Exemplary embodiments of the present invention are described in detail below with reference to the attached drawings.

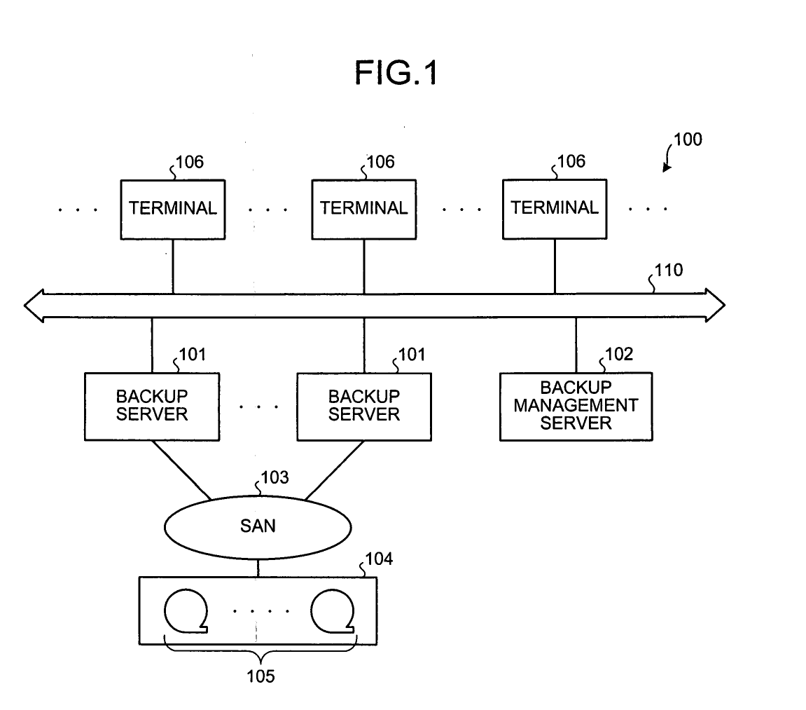

FIG. 1 is a drawing of a data recording system according to an embodiment of the present invention. A data recording system 100 includes backup servers 101, a backup management server 102, a SAN 103, a tape library 104, tape drives 105, and terminals 106. The respective components are connected to one another via a network 110.

Each backup server 101 performs a backup process for data to be recorded. Specifically, the backup server 101 transfers data from the terminals 106 or the backup management server 102 to the tape library 104 via the SAN 103. The backup server 101 is connected via the SAN 103 to each tape drive 105 in the tape library 104.

Therefore, upon accepting an instruction for backup from the backup management server 102, the backup server 101 performs a backup process on a specified tape drive 105. Each backup server 101 has one or more channels. Each channel serves as an interface with fiber channel (FC) cards, for example. The backup server 101 checks a state of connection among the FC cards and the tape drives 105 based on a file for setting drivers of the FC cards.

The backup management server 102 manages a state of connection among the backup servers 101 and the tape drives 105 and a state of connection (usage state) of the tape drives 105. The backup management server 102 stores the state of connection among the FC cards and the tape drives 105 received from each backup server 101 in a usage state table (refer to FIG. 3) regarding the usage state of the tape drives 105. Based on these pieces of information mentioned above, the backup management server 105 performs a backup process, that is, informs one of the backup servers 101 of a tape drive 105 for recording the data. The backup management server 102 can serve as a backup server 101.

The SAN 103 connects the tape drives 105 and the terminals 106 together. The tape library 104 has the tape drives 105. The tape drives 105 are connected to the backup servers 101 via the SAN described above.

Each tape drive 105 includes a magnetic tape as a recording medium to record data transferred from the backup servers 101 via the SAN 103 on the magnetic tape. Description is made by taking the tape drives 105 as an example of recording devices. Alternatively, disk drives using magnetic disks can be used, for example.

General-purpose computers can be adopted as the terminals 106, thereby allowing displays of the state inside the backup server 101 and the usage state of the tape drives 105 on display screens of the terminals 106. Users can instruct or set a backup through the display screens. Specifically, examples of backup settings include a setting in which, when a predetermined condition is satisfied, a backup is automatically performed even without a user's instruction. The backup servers 101, the backup management server 102, or the terminals 106 achieve a data recording device according to the present invention.

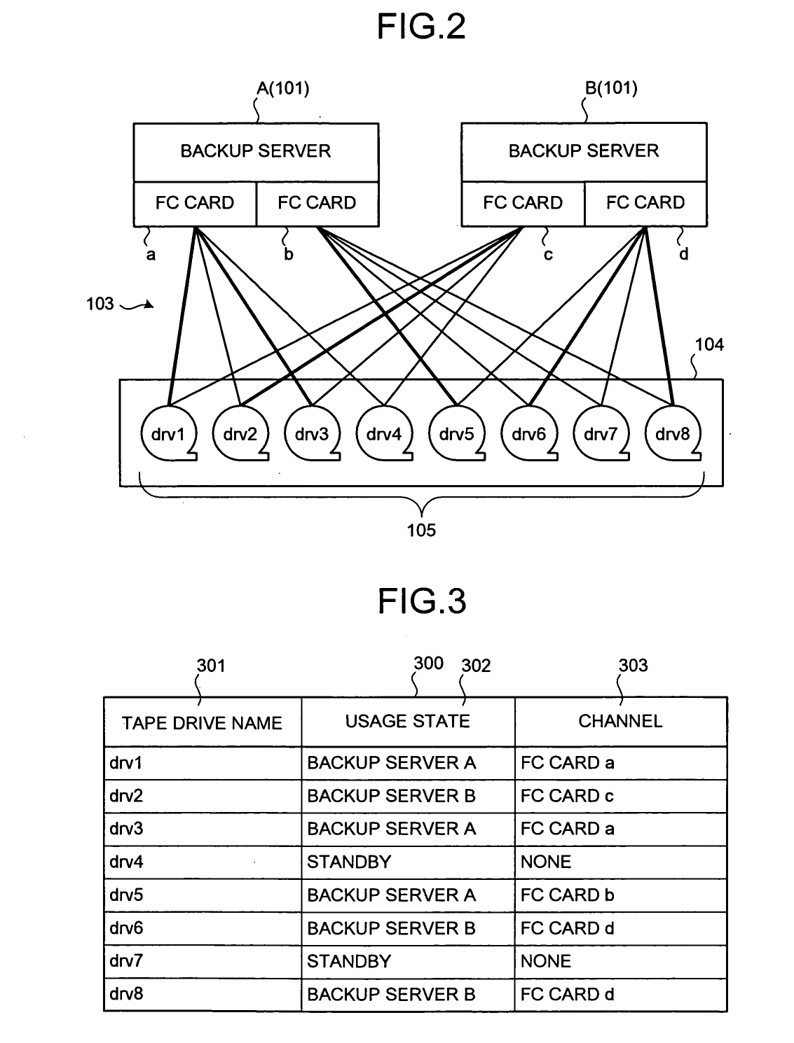

FIG. 2 is a drawing for explaining a connection state of data recording devices according to the embodiment. As for the backup servers 101, two backup servers A and B are used for simplification of description. As for the tape drives 105, eight tape drives drv1 to drv8 are used for simplification of description.

The backup server A includes an FC card a and an FC card b. The backup server B includes an FC card c and an FC card d.

The FC cards are channels the backup servers A and B have, and are interfaces for connection to each tape drives 105 (drv1 to drv8). As described in FIG. 1, the backup servers A and B are connected via the SAN 103 to the tape drives 105 (drv1 to drv8) in the tape library 104.

The SAN 103 is represented by connecting lines that connect the FC cards a to d and the tape drives drv1 to drv8 together. These connecting lines are transfer routes for transferring data from the FC cards a to d to the tape drives drv1 to drv8. The connecting lines denoted as bold lines represent transfer routes.

The FC card a is connected to the tape drives drv1 to drv4, and allows data to be transferred to the tape drives drv1 and drv3. The FC card b is connected to the tape drives drv5 to drv8, and allows data to be transferred only to the tape drive drv5. The FC card c is connected to the tape drives drv1 to drv4, and allows data to be transferred only to the tape drive drv2. The FC card d is connected to the tape drives drv5 to drv8, and allows data to be transferred to the tape drives drv6 and drv8.

FIG. 3 is a drawing of a usage state table regarding the usage state of the tape drives and the backup servers.

A usage state table 300 includes a tape drive name column 301 in which the tape drives drv1 to drv8 in the tape library 104 are listed. A usage state column 302 contains the backup servers 101 of destinations of transfer of data to the respective tape drives drv1 to drv8. For example, on the usage state table 300, it is indicated that the tape drive drv1 performs a backup process on data transferred from the backup server A.

The character string “standby” shown in the usage state column 302 indicates that none of the backup servers 101 is used. For example, as for the tape drive drv4, “standby” is described in the usage state column 302, and therefore the tape drive drv4 is not backed up.

A channel column 303 contains the FC cards of destinations of data transfer. For example, on the usage state table 300, it is indicated that the tape drive drv1 performs a backup process on data transferred from the FC card a of the backup server A.

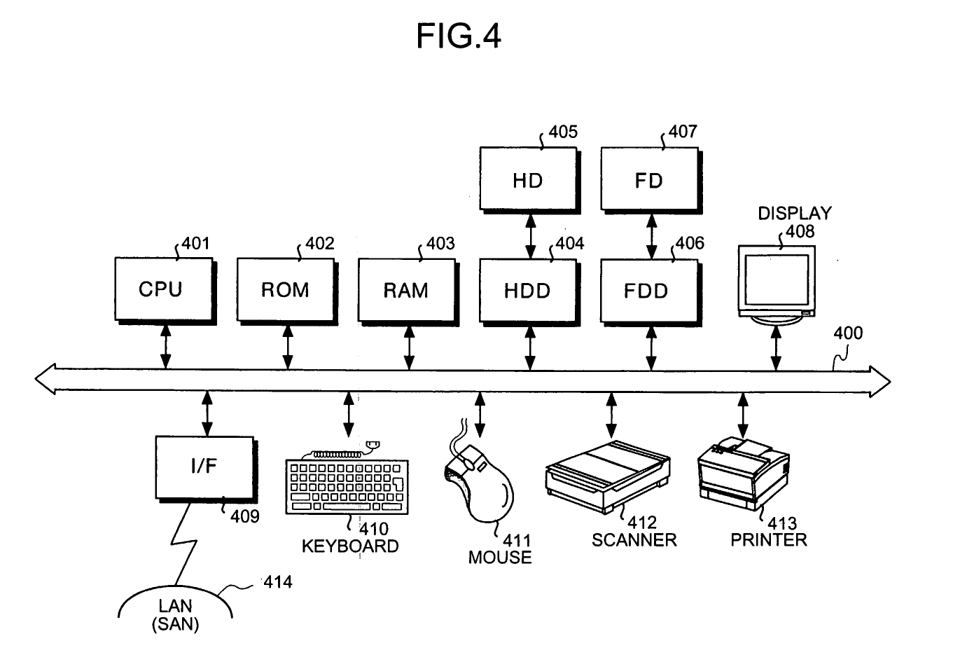

FIG. 4 is a block diagram of the backup server, the backup management server, or the terminal (hereinafter, “the backup server or the like”).

The backup server or the like includes a central processing unit (CPU) 401, a read-only memory (ROM) 402, a random-access memory (RAM) 403, a hard disk drive (HDD) 404, a hard disk (HD) 405, a flexible disk drive (FDD) 406, a flexible disk (FD) 407, which is one example of a removable recording medium, a display 408, an interface (I/F) 409, a keyboard 410, a mouse 411, a scanner 412, and a printer 413. The respective components are connected to one another via a bus 400.

The CPU 401 controls the backup server or the like. The ROM 402 has recorded thereon a program, such as a boot program. The RAM 403 is used as a work area by the CPU 401. The HDD 404 controls either one or both of read on and write from the HD 405 under the control of the CPU 401. The HD 405 has stored therein data written under the control of the HDD 404.

The FDD 406 controls either one or both of read on and write from the FD 407 under the control of the CPU 401. The FD 407 causes data written under the control of the FDD 406 to be stored or causes the data stored in the FD 407 to be read by the backup server or the like.

As a removable recording medium, in addition to the FD 407, a compact disc read-only memory (CD-ROM), such as compact disc-recordable (CD-R) and compact disc rewritable (CD-RW), magneto-optical (MO) disk, digital versatile disk (DVD), and memory card, may be used, for example. The display 408 displays data, such as documents, images, functional information including a cursor, icon, or tool box. As the display 408, a cathode-ray tube (CRT), thin-film transistor (TFT) liquid crystal display, or plasma display can be adopted, for example.

The I/F 409 is connected to a network 414, such as the Internet, via a communication line, and is also connected via the network 414 to another device. The backup management server and the terminal are connected to a local-area network (LAN), a wide-area network (WAN), or the like, while the backup server is connected to the SAN 103, and a LAN, WAN, or the like. The I/F 409 serves as an interface between the network 414 and the inside of the device, and controls data inputs to and outputs from an external device. As the I/F 409, a modem or (LAN) adaptor can be adopted, for example.

The keyboard 410 includes keys for inputs of characters, numbers, various instructions, etc., for data inputs, and may be an input pad of a touch panel type or ten keys, for example. The mouse 411 is used to cause a curse to be moved, an area to be selected, or a window to be moved or changed in size, for example. The mouse 411 may be arbitrary, such as a track ball or joystick, as long as it has a function as a pointing device.

The scanner 412 optically reads an image, and captures image data into the backup server or the like. The scanner 412 may have an optical character recognition (OCR) function. The printer 413 prints image data and document data. As the printer 413, a laser printer or ink jet printer may be adopted.

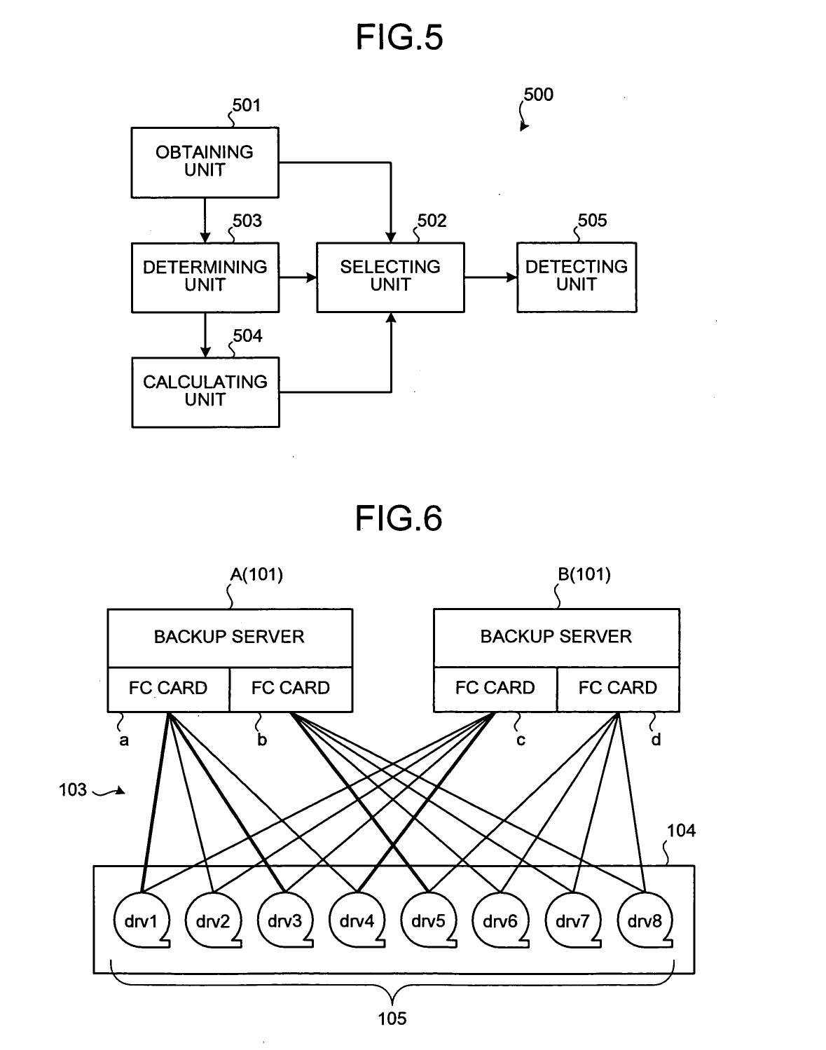

As described above, the data recording device is achieved by any one of computer devices consisting of the backup server, the backup management server, and the terminal shown in FIG. 1. FIG. 5 is a block diagram of the data recording device. A data recording device 500 includes an obtaining unit 501, a selecting unit 502, a determining unit 503, a calculating unit 504, and a detecting unit 505.

The obtaining unit 501 obtains information about a usage state of the recording devices for recording data. The recording devices are the tape drives 105 (drv1 to drv8) and disk drives for recording transferred data. The information about a usage state indicates a usage state of the backup servers 101 performing a backup process by using the recording devices (tape drives), and specifically, for example, is represented by the usage state table 300 shown in FIG. 3.

The selecting unit 502 extracts channels other than a channel having the largest number of transfer routes to the recording device currently in use, from the channels with transfer routes to the recording devices based on the information about the usage state obtained by the obtaining unit 501. The transfer routes are routes for transferring data from the channels to the tape drives 105. Specifically, for example, the transfer routes can be represented by connecting lines connecting the FC cards a to d and the tape drives drv1 to drv8.

Therefore, the number of transfer routes is the number of these connecting lines. Each of the FC cards a to d in FIG. 2 has four transfer routes. Specifically, for example, in FIG. 2, routes denoted as bold lines correspond to the transfer routes.

The channels other than the channel having the largest number of transfer routes to the recording device currently in use are hereinafter referred to as other channels, which are FC cards other than an FC card having the largest number of transfer routes to the tape drive currently in use (such transfer routes are hereinafter “used routes”). Specifically, for example, the FC card a has two used routes, the FC card b has one used route, the FC card c has one used route, and the FC card d has two used routes in FIG. 2. Thus, the FC cards a and d have the largest number of used routes. Therefore, the other channels are other than the FC cards a and d, that is, the FC cards b and c. Therefore, the FC cards b and c are extracted.

Referring back to FIG. 5, in the case where plural other channels have been extracted, the selecting unit 502 selects a channel having the smallest number of used route to the recording device currently in use. A scheme of selecting a channel in the case where plural other channels have been extracted is described. FIG. 6 is a drawing for explaining the connection state of the data recording devices shown in FIG. 2. Components identical to those in FIG. 2 are provided with the same reference numerals, and are not described herein. The FC card a has two used routes, the FC card b has one used route, the FC card c has one used route, and the FC card d has 0 used route.

In this case, the FC cards b, c, and d are first extracted as the other channels. Among the extracted channels, the channel having the smallest number of used routes is the FC card d having 0 transfer route. Therefore, the FC card d is selected.

The determining unit 503 determines whether plural other channels having the same number of transfer routes are present. The case where plural other channels having the same number of transfer routes are present is a case where plural extracted channels are present and the FC cards having the same number of used routes are present. The FC cards b and c extracted as the other routes each has one used route. Therefore, it is determined that plural other channels having the same number of transfer routes are present.

In this case, the selecting unit 502 selects one channel from the channels having the same number of transfer routes to the recording device currently in use, based on the determination result by the determining unit 503. For example, in the case of FIG. 2, the FC cards b and c can be extracted.

When it is determined that plural other channels having the same number of transfer routes are present by the determining unit 503, the calculating unit 504 calculates a time information about a transfer end time. The calculation is performed based on the remaining amount of information being transferred to the recording device currently in use via one of the other channels. Specifically, in the case of FIG. 2, the FC cards b and c are extracted.

The tape drive 105 performing a backup process via a transfer route of the FC card b is the tape drive drv5, while the tape drive 105 performing a backup process via a transfer route of the FC card c is the tape drive drv2. In such a case, each backup server 101 calculates information about the transfer end time from the remaining amount of data currently being subjected to a backup process.

The information about the transfer end time may be information about a time period to be taken from the current time to a scheduled end time of the backup process, or may be a scheduled end time of the backup process. The information about the transfer end time may be calculated by taking, in addition to the remaining amount of the information, an actual transfer rate into consideration.

Based on the calculation results calculated by the calculating unit 504, the selecting unit 502 selects only one channel from the channels having the same number of transfer routes to the tape drive 105 currently in use. Specifically, when plural channels having the same number of used routes are present, for example, in the case of FIG. 2 where the FC cards b and c are extracted, based on the transfer end time calculated by the calculating unit 504, one of the FC cards b and c which allows the transfer process to end earliest is selected.

Based on the information about the usage state obtained by the obtaining unit 501, the determining unit 503 can determine whether a channel other than the channel having the largest number of transfer routes to the recording device currently in use is present among the channels having transfer routes to plurality of recording devices.

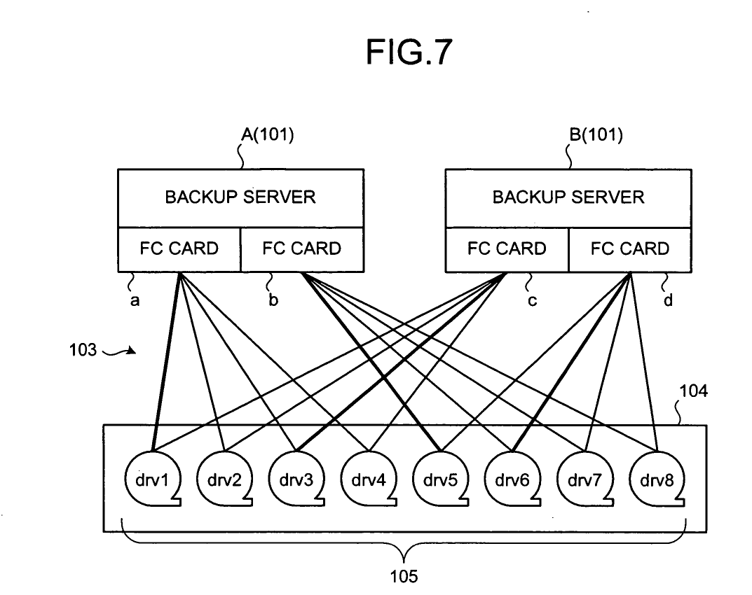

A determination process in this case is described by using FIG. 7. FIG. 7 is another drawing for explaining the connection state of the data recording devices shown in FIG. 2. Components identical to those in FIG. 2 are provided with the same reference numerals, and are not described herein. The FC cards a to d each have connected thereto one used route.

As described above, the other channels are FC cards other than an FC card having the largest number of used routes. Specifically, for example, the used routes are denoted as bold lines in FIG. 7, and the FC card a has one used route, the FC card b has one used route, the FC card c has one used route, and the FC card d has one used route.

When all FC cards have the same number of used routes, it is determined that other channels are not present. Specifically, for example, while no backup process is being performed or when all channels have the same number of used routes, it is determined that other channels are not present.

In this case, based on the determination results by the determining unit 503 as to whether other channels are present, the selecting unit 502 extracts other channels from the channels having a transfer routes to plurality of tape drives 105.

Specifically, for example, in the case of FIG. 2, when it is determined that plural other channels are present, the FC cards b and c can be extracted. When it is determined that no other channels are present and the number of used routes is maximum (all routes are in use), no route is selected. Furthermore, while no backup process is being performed, no other channels are extracted, but in this case, an arbitrary channel is selected.

When it is determined by the determining unit 503 that no other channels are extracted, the calculating unit 504 calculates time information about a transfer end time based on the remaining amount of the information being transferred to the tape drive 105 currently in use via a transfer route of one of the other channels.

In this case, based on the calculation results by the calculating unit 504, the selecting unit 502 selects only one channel from the channels having the same number of used routes. When it is determined by the determining unit 503 that no other channels are extracted, information about a transfer end time is calculated for each channel. The case where no other channels are extracted has been described above, and therefore are not described herein.

Thus, based on the information about the transfer end time, the selecting unit 502 selects a channel having a transfer route allowing a transfer process to end earliest. Specifically, for example, the calculated information about the transfer end time is a time period to be taken until the backup process ends, a channel having a transfer route taking the shortest time period is selected. The calculated information about the transfer end time is a time when the backup process ends, a channel having a transfer route whose time at which the transfer process ends comes earliest is selected.

Based on the information about the usage state obtained by the obtaining unit 501, the detecting unit 505 detects a transfer route for transferring information from the other channel selected by the selecting unit 502 to an unused recording device. Specifically, once one channel is selected by the selecting unit 502, a transfer route currently not in use is detected in transfer routes connected to that channel.

At this time, when the tape drive 105 connected to that transfer route is receiving a transfer of data via another transfer route, the transfer route having connected thereto that tape drive 105 is not detected. For example, in FIG. 6, the FC card a has two transfer routes currently in use, the FC card b has one transfer route currently in use, the FC card c has one transfer route currently in use, and the FC card d has 0 transfer route currently in use. Therefore, the FC card d is selected.

Although all transfer routes connected to the FC card d are not currently in use, a data transfer is performed onto the tape drive drv5 via another transfer route. Therefore, one transfer route is detected in three transfer routes other than the transfer route to the tape drive drv5.

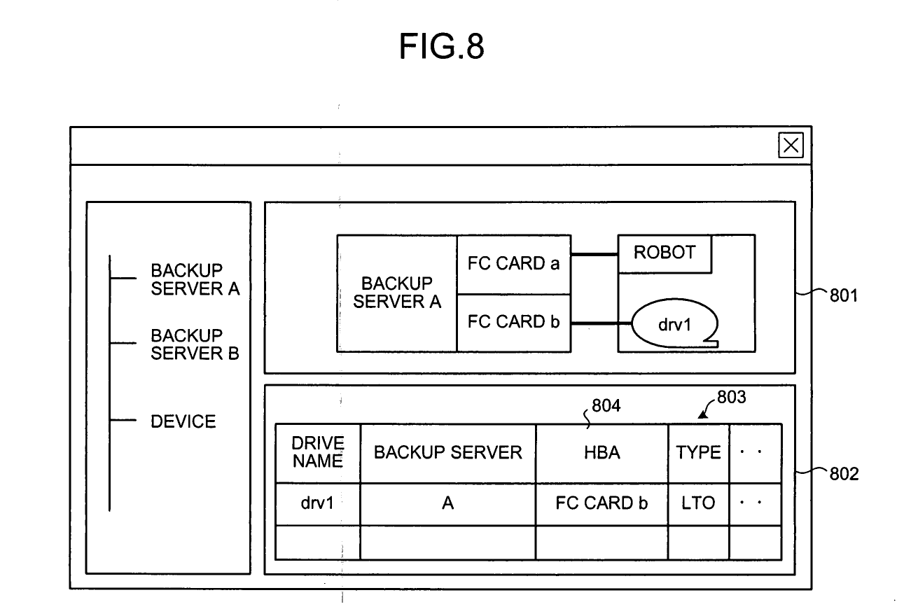

A display screen of the terminal 106 on which the usage state of the tape drives 105 is displayed is described next. FIG. 8 is a drawing of a display screen of a terminal on which the usage state of the tape drives is displayed. A frame 801 depicts a connecting relation between the channels and the tape drives 105. For example, the frame 801 depicts the FC card b and the tape drive drv1 are connected to each other. Details of the inside of the servers are displayed in FIG. 8, and also interface cards incorporated in the servers are also displayed.

The frame 802 displays a table 803 representing a connecting relation between the tape drives 105 and the backup servers 101. A host bus adapter (HBA) (an interface card, specifically, an FC card) column 804 has displayed therein an FC card name to which the tape drive 105 is connected. For example, the tape drive drv1 is connected to the FC card b. With reference to the display screen, the user can know the current usage state of the tape drives 105.

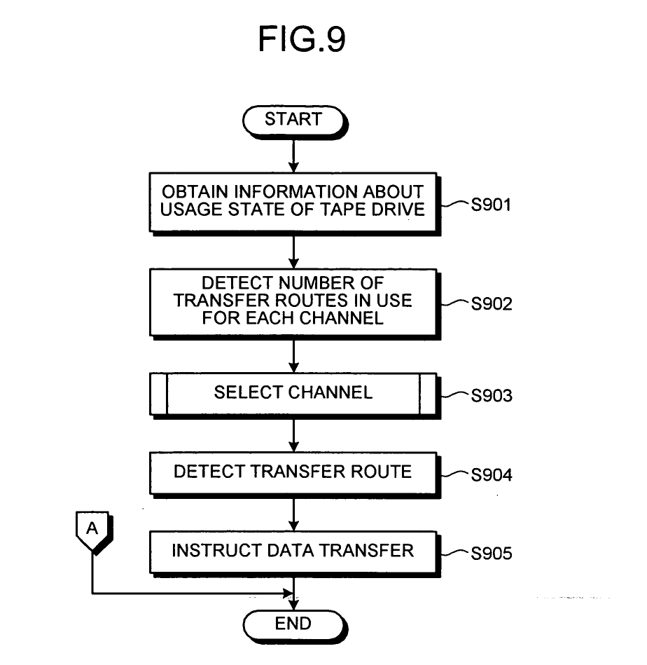

FIG. 9 is a flowchart of a process performed by the data recording device.

The information about the usage state of the tape drives 105 is obtained (step S901). Based on the obtained information, the number of transfer routes currently in use is calculated for each channel (step S902). After a channel is selected (step S903), a transfer route for performing a backup process is detected (step S904), an instruction of transferring data is issued (step S905), and then a series of processes ends.

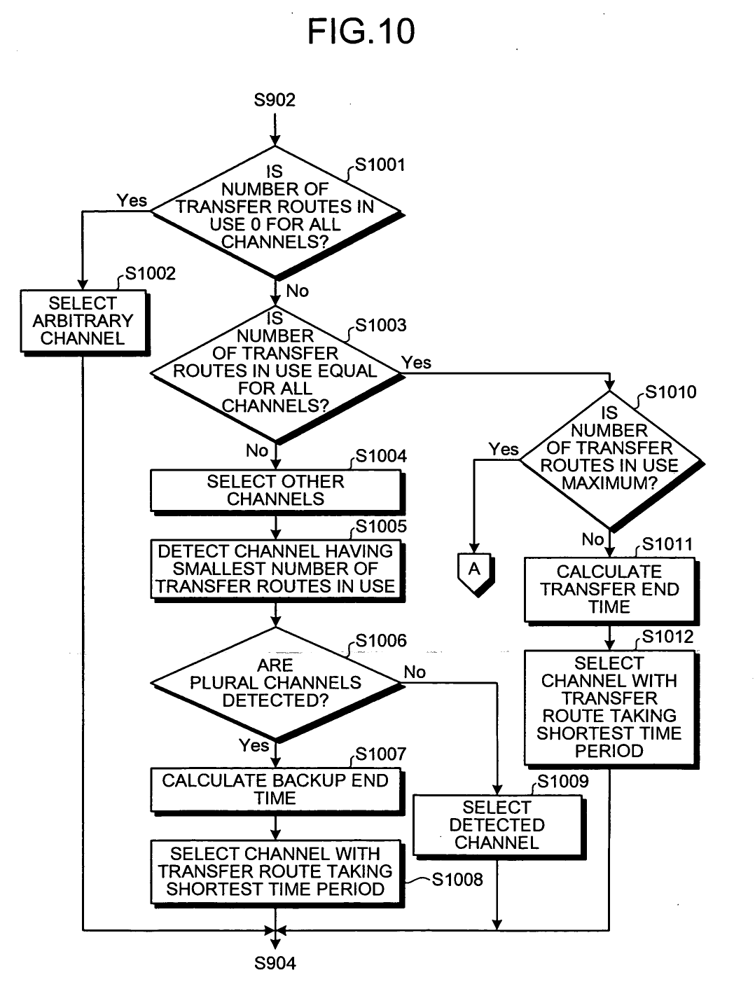

FIG. 10 is a flowchart of a selecting process performed by the data recording device.

After the number of transfer routes is detected for each channel at step S902, it is determined whether the number of transfer routes in use is 0 for all channels (step S1001). It is determined whether a transfer route currently in use for performing a backup process is present. If the number of transfer routes in use is 0 for all channels (“YES” at step S1001), an arbitrary channel is selected (step S1002), and then the procedure goes to step S904 shown in FIG. 9.

On the other hand, if the number of transfer routes in use is not 0 for all channels (“NO” at step S1001), it is then determined whether the number of the transfer routes in use is equal for all channels (step S1003). If the number of the transfer routes in use is equal for all channels (“NO” at step S1003), the other channels are extracted (step S1004). Then, of the extracted other channels, a channel(s) having the smallest number of transfer routes in use is detected (step S1005), and then it is determined whether plural channels are detected (step S1006).

If plural detected channels are detected (“YES” at step S1006), a transfer end time for each channel is next calculated (step S1007). Based on the calculation results, a channel having a transfer route taking the shortest time period until the backup process ends is selected (step S1008). On the other hand, at step S1006, if only one channel is detected (“NO” at step S1006), the channel detected in step S1005 is selected (step S1009), and then the procedure goes to step S904 shown in FIG. 9.

On the hand, at step S1003, if the number of transfer routes in use is equal for all channels (“YES” at step S1003), it is next determined whether the number of transfer routes in use is maximum (step S1010). If the number of transfer routes in use is maximum (“YES” at step S1010), the series of the processes ends. On the other hand, if the number of transfer routes in use is not maximum (“NO” at step S1010), a transfer end time is next calculated for each channel (step S1011). Based on the calculation results, a channel having a transfer route taking the shortest time period until the backup process ends is selected (step S1012), and then the procedure goes to step S904 shown in FIG. 9.

As has been described in the foregoing, according to the embodiment, at the time of data transfer, a recording device connected to an interface unit not having connected thereto a recording device currently in use can be given a higher priority for use than other data recording devices.

As described above, according to the data recording method, the data recording program, the recording medium, and the data recording apparatus, at the time of data transfer, a recording device connected to an interface unit not having connected thereto a recording device currently in use can be given a higher priority for use than other data recording devices. Therefore, a conflict occurring in a transfer band can be suppressed, thereby increasing efficiency in data transfer.

The data recording method described in the present embodiment can be achieved by a computer, such as a personal computer or a work station, executing a program provided in advance. The program is recorded on a computer-readable recording medium, such as a hard disk, flexible disk, CD-ROM, MO disk, or DVD, and is executed by being read from the recording medium by a computer. The program may be a transfer medium that can be distributed via a network, such as the Internet.

According to the present invention, data transfer efficiency can be increased.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A method of recording data in a system including a plurality of channel devices and a plurality of recording devices, the method comprising:
obtaining a usage state of each of the recording devices;
extracting a channel device other than a channel device having a largest number of recording devices that are connected to the channel device and currently used, based on the usage state obtained; and
selecting a recording device that is not currently used from among recording devices that are connected to the channel device extracted, based on the usage state obtained.

2. The method according to claim 1, wherein the extracting includes, when a plurality of channel devices are extracted at the extracting, extracting a channel device having a smallest number of recording devices that are connected to the channel device and currently used.

3. The method according to claim 2, wherein the extracting includes, when a plurality of channel devices are extracted at the extracting, extracting a channel device from among the channel devices extracted.

4. The method according to claim 3, further comprising calculating a time at which a channel device stops using a recording device based on an amount of data to be transferred from the channel device to the recording device, wherein
the extracting includes extracting a channel device that stops using the recording device at earliest time, based on the time calculated.

5. The method according to claim 1, wherein the extracting includes, when no channel device is extracted at the extracting, a channel device from among the channel devices.

6. The method according to claim 5, further comprising calculating a time at which a channel device stops using a recording device based on an amount of data to be transferred from the channel device to the recording device, wherein
the extracting includes extracting a channel device that stops using the recording device at earliest time, based on the time calculated.

7. A computer-readable recording medium that stores a computer program for recording data in a system including a plurality of channel devices and a plurality of recording devices, wherein the computer program causes a computer to execute:
obtaining a usage state of each of the recording devices;
extracting a channel device other than a channel device having a largest number of recording devices that are connected to the channel device and currently used, based on the usage state obtained; and
selecting a recording device that is not currently used from among recording devices that are connected to the channel device extracted, based on the usage state obtained.

8. The computer-readable recording medium according to claim 7, wherein the extracting includes, when a plurality of channel devices are extracted at the extracting, extracting a channel device having a smallest number of recording devices that are connected to the channel device and currently used.

9. A data recording apparatus in a system including a plurality of channel devices and a plurality of recording devices, the apparatus comprising:
an obtaining unit that obtains a usage state of each of the recording devices;
an extracting unit that extracts a channel device other than a channel device having a largest number of recording devices that are connected to the channel device and currently used, based on the usage state obtained; and
a selecting unit that selects a recording device that is not currently used from among recording devices that are connected to the channel device extracted, based on the usage state obtained.

10. The data recording apparatus according to claim 9, wherein when a plurality of channel devices are extracted, the extracting unit extracts a channel device having a smallest number of recording devices that are connected to the channel device and currently used.
